(19) United States
(12) Patent Application Publication
(10) Pub. No.: US 2017/0285575 A1
(43) Pub. Date: Oct. 5, 2017

(54) COLOURED TIMEPIECE COMPONENT

(71) Applicant: The Swatch Group Research and Development Ltd, Marin (CH)

(72) Inventors: Karine TURCOTTE, Quebec (CA); Alexandre HAEMMERLI, Neuchatel (CA)

(73) Assignee: The Swatch Group Research and Development Ltd, Marin (CH)

(21) Appl. No.: 15/471,215

(22) Filed: Mar. 28, 2017

(30) Foreign Application Priority Data
Mar. 29, 2016 (EP) 16162651.0

(51) Int. Cl. G04B 45/00

(52) U.S. Cl. CPC G04B 45/0007; G04B 45/0015

(57) ABSTRACT

The present invention relates to a timepiece component comprising on at least one part of its surface a coating formed of one or more layers of organic pigments.

This application claims priority from European Patent Application No. 16162651.0 filed on Mar. 29, 2016, the entire disclosure of which is hereby incorporated herein by reference.

### SUBJECT OF THE INVENTION

The present invention relates to the technical field of horology. More specifically, it relates to a timepiece component and to a method for depositing coloured layers on the component.

### BACKGROUND OF THE INVENTION AND PRIOR ART

Since aesthetic appearance is particularly important in horology, colouring, or at least making some components visible, is valued.

For example, a balance spring made of material such as glass or quartz, is difficult to see when assembled on its balance wheel, because it is transparent. Currently, to overcome this drawback, it is, for example, machined from unpolished substrates which, as a result of diffuse reflection, produce more noticeable parts. The addition of one or more coloured layers would make the object visible and aesthetically attractive.

For luminous display hands, illumination in a wide range of colours is achieved, for example, by light injection from an LED. Coating the various hands with distinct, thin, coloured layers would allow the hands to be illuminated in a wide range of colours from the same light source, for example a white LED.

Coloured luminescent layers could also be of interest for components illuminated by a light source mounted inside a watch or by an external UV source or by passive illumination by means of fluorescent or phosphorescent pigment layers. In addition to creating aesthetic effects, this could also achieve non-replica marking.

Conventionally, colouring is achieved using coloured lacquers and resins, or via thin interferometric layers, or by cathodic sputtering of oxide and metal sulphide based dyes.

Thus, there is known from EP Patent 2717103, a method for depositing inorganic pigments on timepiece components. The inorganic components have the feature of forming an opaque layer on the substrate. However, it may be advantageous in some applications for the surface condition of the substrate to remain visible after deposition. This makes it possible, for example, to modulate the brightness of the deposited layer depending on the surface condition, whether or not the substrate is polished. Further, this makes it possible for a texture, previously formed on the substrate, to remain visible, or to obtain an effect of depth when the substrate is transparent.

### SUMMARY OF THE INVENTION

The present invention proposes a new method for colouring timepiece components allowing the surface condition of the substrate to be seen after deposition.

To this end, a timepiece component and a method according to the annexed claims are proposed.

### BRIEF DESCRIPTION OF THE DRAWINGS

The features and advantages of the present invention will appear upon reading the detailed description below with reference to the following figures.

FIG. 1 represents, in a known manner, the equipment implemented to achieve the deposition method according to the invention.

FIG. 2 represents, by way of example, a partial view of a dial having textured portions at apertures intended for chronographs. After the deposition of a coloured layer according to the invention, the texture is still visible through the deposited layer.

FIG. 3 represents a crystal after the deposition of a logo made of organic pigments according to the invention.

### LEGEND

(1) Substrate
(2) Pan
(3) Chamber
(4) Pigment preparation
(5) Heat source
(6) Vacuum pumping system
(7) Aperture intended for chronograph
(8) Dial
(9) Crystal

### DETAILED DESCRIPTION OF THE INVENTION

The present invention relates to a method for depositing coloured layers on timepiece components. According to the invention, the deposition is achieved by vacuum evaporation. The present invention more particularly intends to deposit organic pigments which have the advantage of forming a thin semi-transparent layer on the substrate, which allows the structure and/or the surface condition of the substrate to be distinguished.

The substrate may be any timepiece component for which an aesthetic effect is desired. These may be transparent or semi-transparent components made of quartz, glass or ceramic. For example, it could be a balance spring, a hand, appliques, a crystal, a flange, a bridge, a gear train, or any component acting as a light guide, or a transparent watch case back. They may also be opaque substrates such as a dial, a watch case back, an element of the movement, etc.

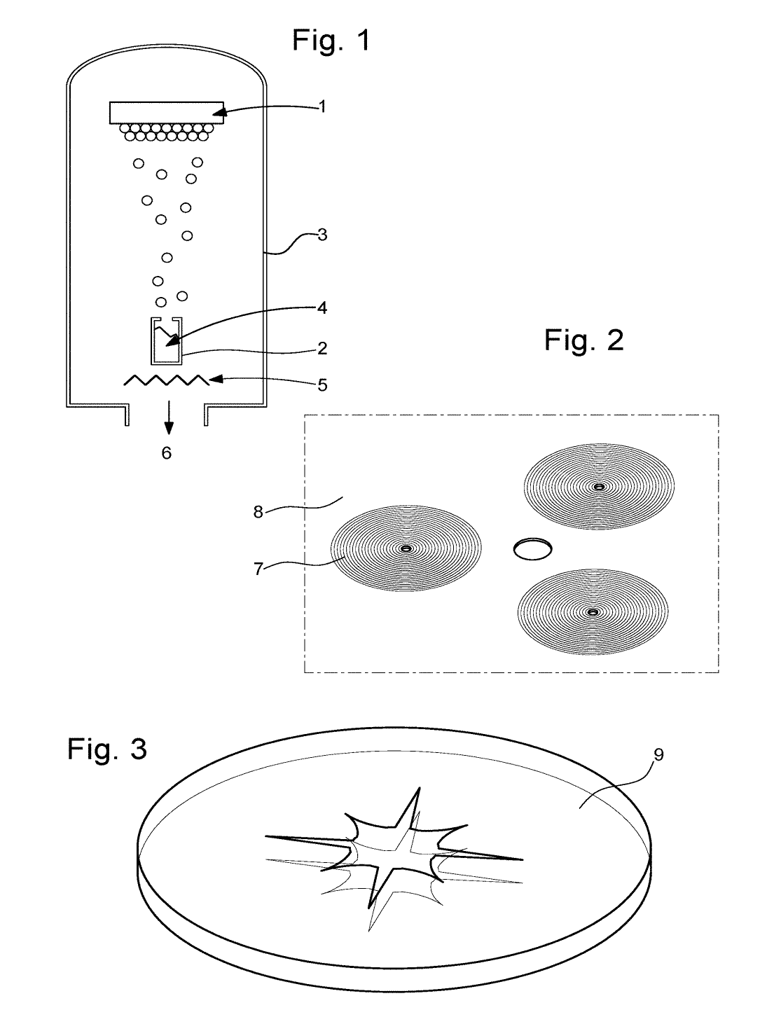

The coloured layers of thickness comprised between 400 and 1500 nm are achieved by heat evaporation. FIG. 1 schematically represents the equipment. In a known manner, the substrate or substrates 1 are secured on a support and pan 2 is placed at the bottom of chamber 3. Once the vacuum is created, the pan containing the pigment preparation 4 is heated by an electric filament 5. The pigment preparation is then sublimated and deposited on the substrate. The deposition is achieved homogeneously by controlling the thickness of the deposited layer which is typically measured in-situ using a quartz microbalance.

The organic pigments are carbon molecules associated with hydrogen, nitrogen or oxygen atoms. The following, non-exhaustive list provides examples of pigments used in the method of the invention: quinophthalone, disazo condensation, monosodium salt (monoazo), isoindolinone, isoindoline, azo compounds, pteridine, diarylide, diketopyrrolopyrrole, benzimidazolone, perylene, β-naphtol (Sr), β-naphtol (Ba), anthraquinone, quinacridone, BONA (Sr), BONA (Ca), dioxazine, Cu-phthalocyanine. According to the invention, luminescent pigments may also be added to the dye pigments.

The pigments in powder form, typically with a particle size of between 5 and 60 μm, are distributed in a solvent such as isopropyl alcohol or butyl acetate. The mixture is cured in a furnace at a low temperature, typically within a range of 40-120° C., and preferably, at a temperature close to 50° C., for several hours to evaporate the solvent and thus obtain a very compact mixture. The mixture thus prepared is vacuum evaporated. According to the invention, a single layer is deposited or several layers of different shades are superposed in order to modulate the colour and optical effects. Optionally, a final, thin, hard, protective layer may be deposited, particularly an oxide layer deposited by cathodic sputtering.

As mentioned above, deposition of an organic pigment layer makes it possible to see the structure or surface condition of the substrate. Thus, if the substrate is polished, the layer appears brilliant, whereas if is not polished it appears matt. If the substrate has a texture, or generally, a pattern with or without relief, the pattern is still visible after deposition. In the example illustrated in FIG. 2, concentric circles were machined in the metal in apertures 7 intended for chronographs on dial 8, in order to create a spinning effect. After deposition, the pattern remains visible as does the polished, brilliant metal finish. Tests performed on metal dials with a texture also produced very good results. It is thus possible to envisage producing any type of pattern on the substrate and keeping the pattern visible after colouring.

Furthermore, an effect of depth or superposition can be obtained by colouring transparent components. A beautiful aesthetic effect can thus be obtained by depositing a coloured logo on a transparent substrate as schematized in FIG. 3. It is also possible to envisage producing the effect of a “fake” ruby or other precious stone by depositing coloured layers on the transparent or semi-transparent substrate.

It is also possible to envisage depositing different coloured layers according to position on the substrate, as well as coloured patterns or structures.

Finally, it will be specified that organic pigments offer a superior colouring power and colour range to those of mineral pigments, which makes it possible to obtain a very good appearance.

1. A timepiece component comprising on at least one part of its surface a coating formed of one or more layers of organic pigments.

2. The timepiece component according to claim 1, comprising several layers respectively formed of different pigments, said layers being superposed or positioned at distinct places on the component.

3. The timepiece component according to claim 1, wherein the pigments are chosen from a list consisting of quinophthalone, disazo condensation, monosodium salt (monoazo), isoindolinone, isoindoline, azo compounds, pteridine, diarylide, diketopyrrolopyrrole, benzimidazolone, perylene, β-naphtol (Sr), β-naphtol (Ba), anthraquinone, quinacridone, BONA (Sr), BONA (Ca), dioxazine, Cu-phthalocyanine.

4. The timepiece component according to claim 1, wherein the layer or layers further include a luminescent pigment.

5. The timepiece component according to claim 1, comprising on a least one part of its surface a pattern with or without relief, visible through the layer or layers.

6. The component according to according to claim 1, being a transparent or semi-transparent component such as a balance spring, a hand, a crystal or a watch case back.

7. The timepiece component according to claim 1, being an opaque component such as a dial or an element of the movement.

8. A watch comprising a timepiece component according to claim 1.

9. A method for coating a timepiece component comprising vacuum evaporation of organic pigments.

10. The method according to claim 9, wherein the pigments are selected from the list consisting of quinophthalone, disazo condensation, monosodium salt (monoazo), isoindolinone, isoindoline, azo compounds, pteridine, diarylide, diketopyrrolopyrrole, benzimidazolone, perylene, β-naphtol (Sr), β-naphtol (Ba), anthraquinone, quinacridone, BONA (Sr), BONA (Ca), dioxazine, Cu-phthalocyanine.

11. The method according to claim 9, wherein the pigments are mixed with a solvent and heated in a temperature range comprised between 40 and 120° C. to form a compact mixture of pigments before sublimation.

12. The method according to claim 9, comprising, after the vacuum evaporation of organic pigments, a step of depositing a final protective layer by cathodic sputtering.

13. The method according to claim 12, wherein the final protective layer is an oxide layer.
